(19) United States
(12) Patent Application Publication
(10) Pub. No.: US 2020/0217333 A1
(43) Pub. Date: Jul. 9, 2020

(54) ACTUATOR

(71) Applicant: KYB CORPORATION, Tokyo (JP)

(72) Inventors: Yoshiyuki OGAWA, Tokyo (JP); Kousuke SATOU, Tokyo (JP); Fumiaki OONO, Tokyo (JP); Ryohei ARAI, Tokyo (JP)

(73) Assignee: KYB CORPORATION, Tokyo (JP)

(21) Appl. No.: 16/649,034

(22) PCT Filed: Aug. 14, 2018
(86) PCT No.: PCT/JP2018/030277

§ 371 Date: Mar. 19, 2020

(30) Foreign Application Priority Data
Jan. 31, 2018 (JP) 2018-014668

(51) Int. Cl. F15B 15/14; C25D 11/04

(52) U.S. Cl. CPC F15B 15/1457; C25D 11/04; F15B 15/1466; F15B 15/1428

(57) ABSTRACT

An actuator includes a cylinder made of an aluminum alloy, a bottom part that closes one end of the cylinder, a cylindrical inner rod that is inserted in the cylinder to form an annular gap to the cylinder, a cylindrical piston rod that is closed at one end, slidably contacts with an outer periphery of the inner rod, and defines, together with the inner rod, an extension-side chamber, and a piston that is provided on the piston rod, slidably contacts with an inner periphery of the cylinder, and defines a compression-side chamber between the cylinder and the piston rod, in which the bottom part has a communication hole leading to the annular gap, and the cylinder has coating formed on the inner periphery by surface treatment using an electrolytic solution.

### TECHNICAL FIELD

The present invention relates to an actuator.

### BACKGROUND ART

In an aircraft, a hydraulic actuator is used to drive steering such as ailerons, a rudder, and an elevator, and to raise and lower a landing gear, or the like. Such a hydraulic actuator includes, for example, a cylinder, a piston slidably inserted in the cylinder, and a piston rod inserted in the cylinder and coupled to the piston. Then, the actuator exhibits extension/contraction operation when pressure oil is supplied from an external pump to any one of an extension-side chamber or compression-side chamber in the cylinder.

Further, because weight reduction is required for an aircraft to improve aircraft performance or fuel efficiency, weight reduction is similarly required for an actuator used in the aircraft. Therefore, some conventional actuators use a cylinder including, as a material, an aluminum alloy having high strength and light weight.

In such an actuator, for example, as disclosed in JP2009-103241A, a sliding surface of a cylinder made of an aluminum alloy may be subjected to surface treatment to form coating having excellent sliding performance and abrasion resistance in order to improve slidability and abrasion resistance.

### SUMMARY OF INVENTION

However, in the above-described actuator, in a case where processing of immersing the cylinder in an electrolytic solution such as sulfuric acid or oxalic acid is adopted when forming coating on a surface of the cylinder, there is a possibility that the electrolytic solution does not flow well and good coating cannot be obtained, because one end of the cylinder is closed.

Accordingly, an object of the present invention is to provide an actuator capable of forming good coating on an inner peripheral surface of a cylinder.

To achieve the above-described object, the actuator includes a cylinder made of an aluminum alloy, a bottom part that closes one end of the cylinder, a cylindrical inner rod that is inserted in the cylinder and forms an annular gap to the cylinder, a cylindrical piston rod that is closed at one end, slidably contacts with an outer periphery of the inner rod, and defines, together with the inner rod, an extension-side chamber, and a piston that is provided on the piston rod, slidably contacts with an inner periphery of the cylinder and defines a compression-side chamber between the cylinder and the piston rod, in which the bottom part has a communication hole leading to the annular gap, and the cylinder has coating formed on the inner periphery by surface treatment using an electrolytic solution.

### BRIEF DESCRIPTION OF DRAWINGS

FIG. 1 is a longitudinal sectional view of an actuator according to one embodiment.

FIG. 2 is a sectional view of a bottom-side part of the actuator according to one embodiment.

FIG. 3 is a left side view of the actuator according to one embodiment.

FIG. 4 is an X-X sectional view of the actuator according to one embodiment.

### DESCRIPTION OF EMBODIMENT

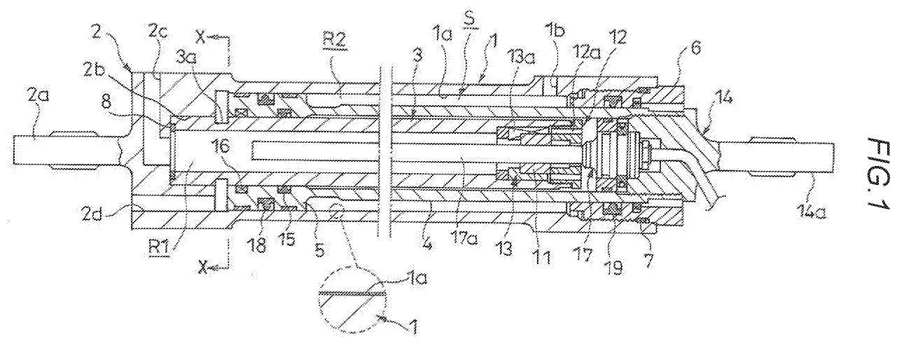

The present invention will be described below on the basis of an embodiment illustrated in the drawings. As illustrated in FIG. 1, an actuator A according to one embodiment includes a cylinder 1 made of an aluminum alloy, a bottom part 2 that closes one end of the cylinder 1, a cylindrical inner rod 3 that is inserted in the cylinder 1, is coupled to the bottom part 2, and forms an annular gap S to the cylinder 1, a cylindrical piston rod 4 that is closed at one end and slidably contacts with an outer periphery of the inner rod 3, and a piston 5 that is provided on the piston rod 4 and slidably contacts with an inner periphery of the cylinder 1.

Each part of the actuator A will be described below in detail. As illustrated in FIG. 1, the cylinder 1 is a cylindrical body made of an aluminum alloy, and closed at one end, which is the left end in FIG. 1, by the bottom part 2. In this example, the cylinder 1 and the bottom part 2 are integrally formed by the aluminum alloy. Further, hard anodic oxide coating la is formed on the inner periphery of the cylinder 1 to improve slidability and abrasion resistance. The aluminum alloy, which is a base material of the cylinder 1 and the bottom part 2, is an alloy in which aluminum contains copper, manganese, silicon, magnesium, zinc, nickel, or the like, and is excellent in strength, and the like, as compared with pure aluminum.

Further, an inner periphery of an opening at another end, which is the right end in FIG. 1, of the cylinder 1 is provided with an annular rod guide 6 that slidably contacts with an outer periphery of the piston rod 4 and guides movement of the piston rod 4 in an axial direction with respect to the cylinder 1. Note that the cylinder 1 includes a pressure inlet 1b, which communicates an inside of the cylinder 1 to an outside of the cylinder 1 to a position in vicinity of the right end in FIG. 1, which does not interfere with the rod guide 6.

The rod guide 6 is screwed into an inner periphery, at the right end in FIG. 1, of the cylinder 1, and an annular seal member 7 is interposed between the cylinder 1 and the rod guide 6. The seal member 7 seals between the cylinder 1 and the rod guide 6. Further, the rod guide 6 includes an annular seal member 19 on the inner periphery. The seal member 19 slidably contacts with the outer periphery of the piston rod 4 to seal between the piston rod 4 and the rod guide 6.

Further, the bottom part 2 includes, at the left end in FIG. 1, an I-shaped bracket 2a that allows the actuator A to be attached to an installation location, and includes a recess 2b that opens in the axial direction from the right end in FIG. 1, a pressure inlet 2c that opens from a side and leads to a bottom of the recess 2b, and a communication hole 2d that opens from a position, which is at the right side, in FIG. 1, of the bottom part 2 and avoiding the recess 2b, and communicates the cylinder 1 to an outside.

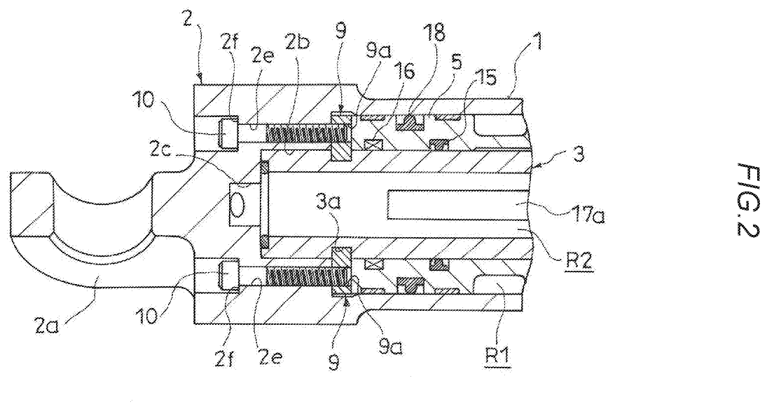

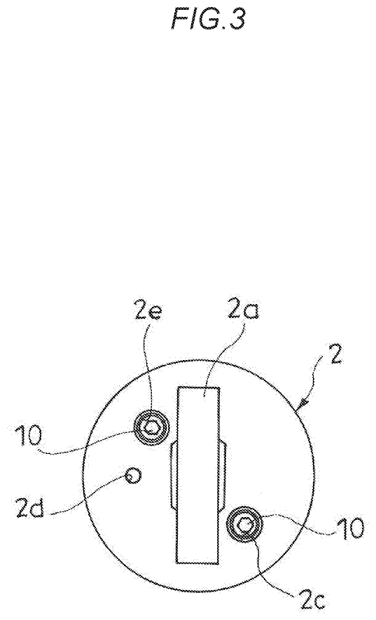

Further, as illustrated in FIGS. 2 and 3, the bottom part 2 includes two through holes 2e, 2e that open from a positions avoiding the bracket 2a, extend in an axial direction of the actuator A, and open to positions avoiding the recess 2b and the communication hole 2d.

The cylindrical inner rod 3 is inserted in the recess 2b of the bottom part 2. Then, the annular gap S is formed between the inner rod 3 and the cylinder 1. The right end, in FIG. 1, of the bottom part 2, which is an outer periphery side of the recess 2b, faces the annular gap S, and the communication hole 2d and the through holes 2e, 2e are communicated with the annular gap S.

An annular seal member 8 is arranged between a bottom of the recess 2b of the bottom part 2 and the inner rod 3, and space between the bottom part 2 and the inner rod 3 is sealed by the above-described seal member 8. Note that the pressure inlet 2c is not closed by the inner rod 3 and the seal member 8, because the pressure inlet 2c opens to the bottom of the recess 2b.

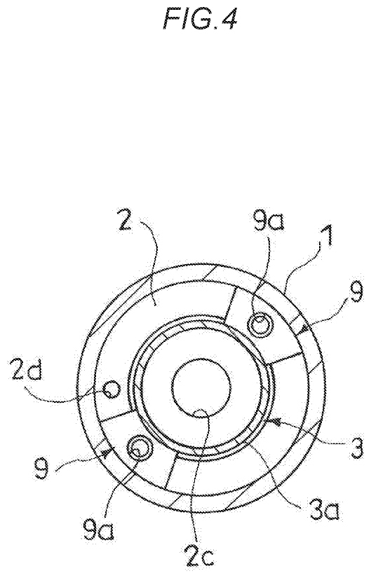

An outer periphery in vicinity of the left end, in FIG. 1, of the inner rod 3 is provided with an annular groove 3a formed over an entire periphery. As illustrated in FIGS. 2 and 4, fan-shaped fixing metal fittings 9, 9 are inserted in the annular groove 3a. Each of the fixing metal fittings 9, 9 is provided with a tapped hole 9a. Further, the through holes 2e, 2e have a diameter that becomes smaller halfway toward the cylinder 1, and include step parts 2f, 2f halfway. Then, when bolts 10, 10 are inserted in the through holes 2e, 2e and screwed into the tapped holes 9a, 9a, heads of the bolts 10, 10 abut against the step parts 2f, 2f, the inner rod 3 is drawn into an inside of the recess 2b of the bottom part 2 via the fixing metal fittings 9, 9, and the inner rod 3 is fixed to the bottom part 2. Then, because position of an axial direction of the fixing metal fittings 9, 9 can be adjusted by rotation operation of the bolts 10, 10, load applied to the seal member 8, which is held between the inner rod 3 and a bottom of the bottom part 2, can be controlled. Note that, although the fixing metal fittings 9, 9 may come into contact with the bottom part 2 in a state where the inner rod 3 is fixed to the bottom part 2, the fixing metal fittings 9, 9 are arranged at positions where the fixing metal fittings 9, 9 do not face the communication hole 2d in the axial direction so as not to block the communication hole 2d. Note that fastening of the inner rod 3 to the bottom part 2 is not limited to the above-described structure, and screw fastening, press-fitting, or other fastening method may be adopted.

An annular head cap 12 is screwed into, and a permanent magnet 11 is attached to an inner periphery of the right end, in FIG. 1, of the inner rod 3. The head cap 12 is provided with a passage 12a, and a holder 13, which holds the permanent magnet 11 and is mounted on the inner periphery of the inner rod 3, is also provided with a passage 13a. Therefore, an inside of the inner rod 3 leads to an outside of the inner rod 3 via the passages 12a, 13a.

The piston rod 4 is cylindrical and provided with a cap 14 mounted on one end, which is the right end in FIG. 1, the cap including an I-shaped bracket 14a that allows the actuator A to be attached to the installation location. Therefore, the one end, which is the right end in FIG. 1, of the piston rod 4 is closed by the cap 14. Further, the piston rod 4 slidably contacts with the outer periphery of the inner rod 3, is movable in the axial direction with respect to the cylinder 1 and the inner rod 3, and includes annular seal members 15, 16, which slidably contact with the outer periphery of the inner rod 3 on an inner periphery of the left end in FIG. 1. Therefore, an inside of the piston rod 4 and the inner rod 3 forms space that is expanded or contracted by relative movement of the piston rod 4 and the inner rod 3 in the axial direction, and this space forms an extension-side chamber R1. That is, the piston rod 4, together with the inner rod 3, defines the extension-side chamber R1. The extension-side chamber R1 leads to the pressure inlet 2c, so that supply of liquid to the extension-side chamber R1 and discharge of liquid from the extension-side chamber R1 are possible via the pressure inlet 2c.

The cap 14 holds a stroke sensor 17 including a sensor rod 17a that accommodates a magnetostrictive wire that detects the axial direction position of the permanent magnet 11. The sensor rod 17a is inserted in the inner rod 3 via an inner periphery of the above-described head cap 12 and an inner periphery of the above-described permanent magnet 11. Then, the stroke sensor 17 applies a current pulse to the magnetostrictive wire in order to generate a magnetic field on an outer periphery of the magnetostrictive wire, and then outputs a signal corresponding to time required for an oscillation pulse, which is generated at a portion facing the permanent magnet 11 due to the Wiedemann effect, to return. With this arrangement, displacement of the piston rod 4 in the axial direction with respect to the inner rod 3 can be detected from the signal output by the stroke sensor 17. Note that, although the stroke sensor 17 is installed to feed back the displacement detected by the stroke sensor 17 and control extension and contraction of the actuator A in this embodiment, the stroke sensor 17 may not be used if unnecessary.

The outer periphery of the left end, in FIG. 1, of the piston rod 4 is provided with the annular piston 5, which slidably contacts with the inner periphery of the cylinder 1. The outer periphery of the piston 5 is provided with an annular seal member 18, which slidably contacts with the inner periphery of the cylinder 1, and space between the piston 5 and the cylinder 1 is sealed by the seal member 18. The piston 5 divides the annular gap S between the cylinder 1 and the inner rod 3 into space between the cylinder 1 and the piston rod 4, and space between the cylinder 1 and the inner rod 3, the space facing the bottom part 2. Then, the space between the cylinder 1 and the piston rod 4 forms a compression-side chamber R2. Thus, the piston 5 defines the compression-side chamber R2 between the cylinder 1 and the piston rod 4. This compression-side chamber R2 leads to the pressure inlet 1b provided on the cylinder 1, so that supply of liquid to the compression-side chamber R2 and discharge of the liquid from the compression-side chamber R2 are possible via the pressure inlet 1b.

Then, a pressure receiving area that receives pressure of the compression-side chamber R2 in a direction of pushing the piston rod 4 leftward in FIG. 1 with respect to the cylinder 1 is an area obtained by subtracting a cross-sectional area of the outer periphery of the piston rod 4 from a cross-sectional area of the inner periphery of the cylinder 1. A pressure receiving area that receives pressure of the extension-side chamber R1 in a direction of pushing the piston rod 4 rightward in FIG. 1 with respect to the cylinder 1 is a cross-sectional area of the outer periphery of the inner rod 3. In this embodiment, the pressure receiving area that receives the pressure of the extension-side chamber R1 and the pressure receiving area that receives the pressure of the compression-side chamber R2 are equal.

The actuator A configured as described above, when supplying liquid such as hydraulic oil to the extension-side chamber R1 and discharging the liquid from the compression-side chamber R2, exhibits extension operation by the liquid supplied to the extension-side chamber R1 pushing the piston rod 4 out of the inside of the cylinder 1. Conversely, the actuator A, when supplying liquid such as hydraulic oil to the compression-side chamber R2 and discharging the liquid from the extension-side chamber R1, exhibits compression operation by the liquid supplied to the compression-side chamber R2 pushing the piston 5 to cause the piston rod 4 to enter the inside of the cylinder 1.

Then, in the actuator A configured in this manner, as described above, the pressure receiving area that receives the pressure of the extension-side chamber R1 and the pressure receiving area that receives the pressure of the compression-side chamber R2 are equal. Therefore, if the pressure of the extension-side chamber R1 when the actuator A performs extension operation and the pressure of the compression-side chamber R2 when the actuator A performs compression operation are the same, the actuator A exhibits thrust force that is the same in magnitude and different only in direction on the extension operation and the compression operation. That is, this actuator A functions as a double-rod type, direct-acting cylinder. Then, because the communication hole 2d leads to the annular gap S, and space between the piston 5 and the bottom part 2 is opened to the atmosphere and is always at the atmospheric pressure, the above-described space does not function as an air spring. Therefore, extension/contraction operation of the actuator A is not hindered by the above-described space, and the actuator A can smoothly extend and contract.

Then, to form hard anodic oxide coating on the inner periphery of the cylinder 1 in the actuator A, the following is performed. The cylinder 1 closed at one end by the bottom part 2 is immersed in an electrolytic solution such as sulfuric acid or oxalic acid, the cylinder 1 is held by an anode connected to a positive electrode of power supply, and the cylinder 1 is energized by connecting a cathode, which is separated from the cylinder 1 in the electrolytic solution, to a negative electrode of the power supply. Then, the cylinder 1 and the bottom part 2 are subjected to anodization treatment (alumite treatment), and the hard anodic oxide coating la is formed on the inner peripheral surface of the cylinder 1. Note that, by the above-described treatment, the hard anodic oxide coating is formed on all parts except for a contact point between the cylinder 1 and the anode, and a contact between the bottom part 2 and the anode.

In this anodization treatment, the cylinder 1 is immersed in the electrolytic solution, and because an inside and outside of the cylinder 1 are communicated by the communication hole 2d, the electrolytic solution can flow, and good hard anodic oxide coating la can be formed on the inner peripheral surface of the cylinder 1.

The hard anodic oxide coating la has excellent slidability and abrasion resistance as compared with an aluminum alloy that has not been subjected to anodization treatment (alumite treatment), and can reduce abrasion of the cylinder 1 caused by sliding of the piston 5.

Further, plasma electrolytic oxidation coating that forms crystalline ceramic coating having a fine structure on a surface of the cylinder 1 by underwater plasma in a state where the cylinder 1 is immersed in the electrolytic solution may be formed. In this case also, the cylinder 1 is immersed in the electrolytic solution, and because the inside and outside of the cylinder 1 are communicated by the communication hole 2d, the electrolytic solution can flow, and good coating can be formed on the inner peripheral surface of the cylinder 1. Because the plasma electrolytic oxidation coating also has excellent slidability and abrasion resistance, the plasma electrolytic oxidation coating may be formed on the inner peripheral surface of the cylinder 1 by applying plasma electrolytic oxidation treatment, instead of hard anodization treatment.

Note that, although coating is formed on the inner periphery of the communication hole 2d when coating such as the hard anodic oxide coating la or the plasma electrolytic oxidation coating is formed on the inner peripheral surface of the cylinder 1 because the electrolytic solution flows in the communication hole 2d, the coating may be removed if the inner periphery of the communication hole 2d is better without the coating.

As described above, the actuator A according to the present invention includes a cylinder 1 made of an aluminum alloy, a bottom part 2 that closes one end of the cylinder 1, a cylindrical inner rod 3 that is inserted in the cylinder 1 to form an annular gap S to the cylinder 1, a cylindrical piston rod 4 that is closed at one end, slidably contacts with the outer periphery of the inner rod 3, and defines, together with the inner rod 3, an extension-side chamber R1, and a piston 5 that is provided on the piston rod 4, slidably contacts with the inner periphery of the cylinder 1, and defines a compression-side chamber R2 between the cylinder 1 and the piston rod 4, in which the bottom part 2 has the communication hole 2d leading to the annular gap S, and the cylinder 1 has coating la formed on the inner periphery by surface treatment using an electrolytic solution. In the actuator A configured in this manner, because the electrolytic solution can flow the inside and outside of the cylinder 1 by the communication hole 2d when the surface treatment of the cylinder 1 is performed, good coating la can be formed, and slidability and abrasion resistance are improved. Thus, by the actuator A of the present invention, it is possible to form the good coating la on the inner peripheral surface of the cylinder 1. Then, furthermore, because the annular gap S excluding the compression-side chamber R2 is opened to the atmosphere by the communication hole 2d, the actuator A can smoothly extend and contract when the actuator A is driven. Thus, in the actuator A of the present invention, the communication hole 2d can be used for both improving fluidity of the electrolytic solution during surface treatment of the cylinder 1 and compensating for smooth extension/contraction operation during driving of the cylinder 1.

Although the preferred embodiment of the present invention has been described in detail above, modifications, variations, and changes can be made without departing from the scope of the claims.

The present application claims priority based on Patent Application No. 2018-014668 filed on Jan. 31, 2018 to the Japanese Patent Office, and the entire contents of this application are incorporated herein by reference.

1. An actuator comprising:
a cylinder made of an aluminum alloy;
a bottom part that closes one end of the cylinder;
a cylindrical inner rod that is inserted in the cylinder and coupled to the bottom part, and forms an annular gap to the cylinder;
a cylindrical piston rod that is closed at one end, slidably contacts with an outer periphery of the inner rod, is movable in an axial direction with respect to the cylinder and the inner rod, and defines, together with the inner rod, an extension-side chamber; and
a piston that is provided on the piston rod, slidably contacts with an inner periphery of the cylinder, and defines a compression-side chamber between the cylinder and the piston rod,
wherein the bottom part has a communication hole leading to the annular gap, and
the cylinder has coating formed on the inner periphery by surface treatment using an electrolytic solution.

2. The actuator according to claim 1,
wherein the coating is hard anodic oxide coating or plasma electrolytic oxidation coating.
